(19) United States
(12) Patent Application Publication
(10) Pub. No.: US 2023/0356315 A1
(43) Pub. Date: Nov. 9, 2023

(54) Cold Working During Additive Manufacturing

(71) Applicant: Relativity Space, Inc., Long Beach, CA (US)

(72) Inventors: Bryan Watson, Los Angeles, CA (US); Erik Richman, Long Beach, CA (US); Kevin O'Neill, Long Beach, CA (US); Bishop Wright, Manhattan Beach, CA (US)

(73) Assignee: Relativity Space, Inc., Long Beach, CA (US)

(21) Appl. No.: 18/312,437

(22) Filed: May 4, 2023

Related U.S. Application Data
(60) Provisional application No. 63/338,389, filed on May 4, 2022.

(51) Int. Cl. B23K 9/04; B33Y 30/00; B33Y 40/20

(52) U.S. Cl. CPC B23K 9/044; B33Y 30/00; B33Y 40/20

(57) ABSTRACT

A system and method are disclosed for cold working an additively manufactured component including a platform, a deposition robot, and a roller assembly. The platform is configured to support a three-dimensional object. The deposition robot is configured to deposit successive material layers that, after deposition, form the three-dimensional object. The deposition robot includes an arm having a deposition end and a deposition head coupled to the deposition end of the arm. The deposition head is configured to deposit a new material later of the successive material layers. The roller assembly is disposed around the new material layer and configured to compress a lateral thickness of the new material layer after the new material layer has been deposited by the deposition robot.

### CROSS-REFERENCE TO RELATED APPLICATIONS

The present application claims priority to U.S. provisional patent application No. 63/338,389, filed May 4, 2022, the disclosure of which is incorporated herein by reference.

### TECHNICAL FIELD

Aspects of the present disclosure relate to components, systems, and methods for additive manufacturing.

### BACKGROUND

Additive manufacturing, or three-dimensional (3-D) printing, uses design models and hardware to deposit material (e.g., metal) in layers to construct precise geometric components. Wire Arc Additive Manufacturing (WAAM) is a type of additive manufacturing that can be used to print or repair 3D metal components. In WAAM, a metal wire is provided from a tip of a welding robot while heat energy is applied to the metal wire. The heat energy melts the wire to allow it to be welded on itself in accordance with a design.

### SUMMARY

The present disclosure may comprise one or more of the following features and combinations thereof. The descriptions herein represent non-limiting invention embodiments.

In some embodiments systems and methods are disclosed for cold working an additively manufactured component including a platform, a deposition robot, and a roller assembly. The platform is configured to support a three-dimensional object. The deposition robot is configured to deposit successive material layers that, after deposition, form the three-dimensional object. The deposition robot includes an arm having a deposition end and a deposition head coupled to the deposition end of the arm. The deposition head is configured to deposit a new material layer of the successive material layers. The roller assembly is disposed around the new material layer and configured to compress a lateral thickness of the new material layer after the new material layer has been deposited by the deposition robot.

Various embodiments of the disclosure are direct to systems for working an additively manufactured component, the system including:
a platform configured to support a three-dimensional object;
a deposition robot configured to deposit successive material layers that, after deposition, form the three-dimensional object, the deposition robot including:
   an articulating robotic arm having a deposition end;
   a deposition head, coupled to the deposition end of the arm, and configured to deposit a new material layer of the successive material layers; and
a roller assembly disposed around the new material layer and configured to compress a lateral thickness of the new material layer after the new material layer has been deposited by the deposition robot.

In still various embodiments, the roller assembly is coupled to the articulating robotic arm and spaced apart from the deposition head.

In yet various embodiments, the roller assembly is coupled to a second articulating robotic arm independent of the articulating robotic arm of the deposition robot.

In still yet various embodiments, the platform rotates around an axis and the three-dimensional object has a continuous perimeter.

In yet still various embodiments, the roller assembly is circumferentially spaced apart from the deposition robot around the axis.

In still yet various embodiments, the roller assembly includes a first roller that rotates around a first roller axis and a second roller that rotates around a second roller axis, the first and second rollers are axially aligned with the new material layer.

In yet still various embodiments, the first and second rollers include a rolling surface, each rolling surface extending axially and configured to engage the new material layer and a second material layer.

In still yet various embodiments, the rolling surface is convex.

In yet still various embodiments, the roller assembly is rotatable around a pivot axis such that the first and second rollers are spaced apart from each other tangential to the new material layer.

In still yet various embodiments, the first and second rollers are coupled to a motor and configured to rotate to reduce friction between the first and second rollers and the new material layer.

In yet still various embodiments, the roller assembly further comprises an articulation device to control at least one of a compressive force acting on the new material layer by the first and second rollers and a distance between the first and second rollers.

In still yet various embodiments, the first and second rollers have a conical cross-section and wherein the first and second axes are non-parallel.

In yet still various embodiments, the first roller is supported by a first support arm and the second roller is supported by a second support arm.

In still yet various embodiments, the roller assembly further includes cooling passages configured to supply a cooling medium to the new material layer.

In yet still various embodiments, the platform extends linearly and the three-dimensional object is a wall.

Many embodiments of the disclosure are directed to systems for cold working an additively manufactured component, the system including:
a platform configured to support a three-dimensional object;
a deposition robot configured to deposit a new successive material layers that, after deposition, form the three-dimensional object, the deposition robot including:
   an articulating robotic arm having a deposition end;
   a deposition head, coupled to the deposition end of the articulating robotic arm, configured to deposition a new material later of the successive material layers; and
a power supply coupled to the deposition robot; and
a roller assembly disposed around the new material layer and configured to compress a lateral thickness of the new material layer after the new material layer has been deposited by the deposition robot.

In still many embodiments, the roller assembly is coupled to the articulating robotic arm and spaced apart from the deposition head.

In yet many embodiments, the roller assembly is coupled to a second articulating robotic arm independent of the articulating robotic arm of the deposition robot.

In still yet many embodiments, the platform rotates around a pivot axis and the three-dimensional object has a continuous perimeter.

Several embodiments of the disclosure are directed to deposition robots configured to deposit successive material layers that, after deposition, form the three-dimensional object, the deposition robot including:
an articulating robotic arm having a deposition end;
a deposition head, coupled to the deposition end of the arm, configured to deposit a new material layer of the successive material layers; and
a roller assembly coupled to the articulating robotic arm and spaced apart from the deposition head, wherein the roller assembly is disposed around the new material layer and configured to compress a lateral thickness of the new material layer after the new material layer has been deposited by the deposition robot.

Further features and advantages, as well as the structure and operation of various embodiments, are described in detail below with reference to the accompanying drawings. It is noted that the specific embodiments described herein are not intended to be limiting. Such embodiments are presented herein for illustrative purposes only. Additional embodiments will be apparent to persons skilled in the relevant art based on the teachings contained herein.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the pertinent art to make and use the disclosure.

FIG. 1 is a diagrammatic perspective view of a system for cold working an additively manufactured component, according to some embodiments of the present disclosure.

FIG. 2A is a diagrammatic cross-sectional view of component 12 along the line A-A of FIC. 2C after new material layer is deposited, according to some embodiments of the present disclosure.

FIG. 2B is a diagrammatic cross-sectional view of component 12 along the line B-B of FIG. 2C after cold rolling, according to some embodiments of the present disclosure.

FIG. 2C is a diagrammatic top view of a system for cold working an additively manufactured component showing a welding head adjacent to a roller assembly, according to some embodiments of the present disclosure.

FIG. 3 is a diagrammatic cross-sectional view of a roller assembly showing an additively manufactured component between adjacent rollers of a roller assembly, according to some embodiments of the present disclosure.

FIG. 4 is a diagrammatic top view of a system for cold working an additively manufactured component showing a welding robot with an articulation arm spaced apart from a roller assembly with a separate articulation arm, according to some embodiments of the present disclosure.

FIG. 5 is a diagrammatic cross-sectional view of a roller assembly showing rollers rotatably coupled to drive motors for rotating the rollers, according to some embodiments of the present disclosure.

FIG. 6 is a diagrammatic cross-sectional view of a roller assembly showing an articulation device coupled between rollers to allow movement between the rollers, according to some embodiments of the present disclosure.

FIG. 7 is a diagrammatic cross-sectional view of a roller assembly showing conical shaped rollers, according to some embodiments of the present disclosure.

Aspects of the present disclosure will be described with reference to the accompanying drawings.

### DEFINITIONS

For the purposes of the present disclosure, terms listed in this section are given the following meaning:
Cold working means working a metal below the metal's recrystallization temperature.
Layer means a single pass of WAAM deposited material.
Multiple layers means multiple passes of WAAM deposited material stacked adjacent to each other.
Parasitic mass means the mass that does not have a beneficial contribution to the function of a component.
Wire arc additive manufacturing or WAAM means a process where a metal wire is provided from a tip of a welding robot while heat energy is applied to the metal wire and the heat energy melts the wire to allow it to be layered in the desired shape of the component being manufactured.

### DETAILED DESCRIPTION

Provided herein are system, apparatus, device, and/or method embodiments, and/or combinations and sub-combinations thereof for cold working an additively manufactured component.

In Wire Arc Additive Manufacturing (WAAM), a metal wire is provided from a tip of a welding robot while heat energy is applied to the metal wire. The heat energy melts the wire to allow it to be layered in the desired shape of the component being manufactured. During deposition of new material layers, various parameters at the welding head combine to produce deposit bead geometry. Undulations in the deposited material form circumferentially or lengthwise along the deposited layer and also axially or in the height direction of the component between adjacent deposited layers. The undulations create a non-smooth surface finish of the component that can reduce strength of the component, increase parasitic mass in the component, and reduce corrosion resistance of the component. These material deficiencies may be resolved by post processing the WAAM components to improve the surface finish. Cold working, for example, can flatten the surface to improve corrosion resistance and also improve material strength by refining the grain structure of the component.

At a typical fused region between a newly deposited material layer and an adjacent layer, small valley-like structures may form at the interface creating stress concentrations and a weak point in the component. For thin walled components, these valley structures may form a substantial portion of the thinnest section of the component. Further, the weld bead swells outward producing a thick section of the wall. In some embodiments, for example, a thin walled component may have a desired wall thickness of 3.8 mm to 12 mm and the thick section of the weld bead may be 3% to 10% greater than the desired wall thickness. The typical strength in a thin walled component will be a function of the thinnest cross-sectional width, so the additional thickness of weld bead creates additional mass in the component that does not provide additional strength in the direction most beneficial to the component. The section of the weld bead that extends outward from the thinnest section of the wall is excess material and referred to as parasitic mass for weight sensitive components. For example, in a WAAM component with desired wall thickness of 3.8 mm to 12 mm that weighs 4,500 kg, the additional thickness created by the weld bead could be 140 kg to 450 kg. Milling may remove the valley-like structures at the bond and remove parasitic mass but will also produce waste material.

Certain embodiments include the inventive realization that cold working applies a compressive force to plastically deform the material to remove the valley-like structures and also refine the grain microstructure of the material at the thinnest section of the component making the component stronger overall. The inventors also realized that applying cold working removes parasitic mass. For example, although the mass of the material after cold working may be the same or nearly the same as if the material had thick sections of the weld bead, the mass that did not previously have a beneficial contribution to the function of a component may serve to provide strengthening properties after cold working.

Aspects herein solve a technological problem associated with parasitic mass using a system that deposits and cold works during manufacture of a three-dimensional printed component. It should be understood that in various embodiments of the disclosed invention, cold working of the component may occur at any time while new material is being deposited. For example, the new material can be cold worked immediately after the material has been deposited. Or the new material can be cold worked sometime after the material has been deposited when it has cooled. In one such embodiment, the new material can be cold worked immediately before another layer of new material is deposited. In at least one embodiment, rollers may plastically deform one layer of deposited material at a time, instead of multiple layers, thereby reducing the compressive force used and allowing the material to plastically deform more easily than if multiple layers were cold worked simultaneously. The system may improve material quality, reduce the number of separate manufacturing operations on a component, and improve lead time of delivering a finished component. This innovative procedure allows for large scale components to be welded and post processed as part of the same operation.

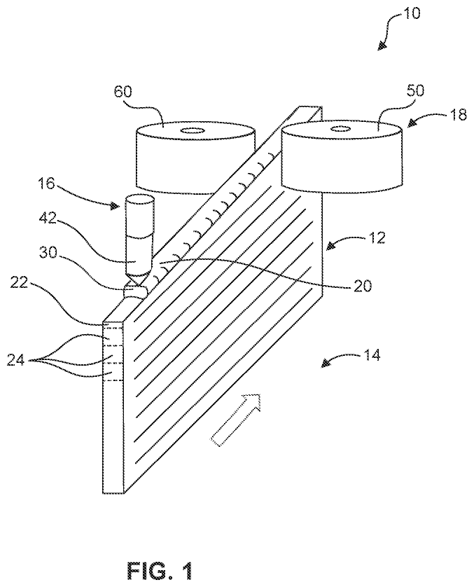

FIG. 1 is a diagrammatic view of a system 10 for cold working an additively manufactured component 12 including a platform 14, a welding robot 16, and a roller assembly 18. The component 12 is supported and translated by the platform 14 relative to the welding robot 16 and roller assembly 18. The welding robot 16 includes a welding head 42 that deposits beads of new material 30 and thus new material layer 20 onto the component 12 as the component 12 is translated by the platform underneath the welding head 42. The roller assembly 18 is located adjacent to the welding head 42 and compresses a thickness of the new material layer 20 in the width direction. The roller assembly 18 cold works the new material layer 20 to redistribute the material in the new material layer 20 and reduce parasitic mass in the component 12.

It should be understood that various embodiments of the invention disclosed, working of the material might take place at various temperatures including but not limited to freezing, ambient temperature, above the metal's recrystallization temperature, or above the melting point.

The additively manufactured component 12 is a three-dimensional object that is constructed by depositing consecutive material layers on top of each other in the axial direction as shown in FIG. 1. A new material layer 20 of component 12 can be deposited in any desired shape on platform 14 by adjusting the relative positions of the welding head 42 and the platform 14. The deposited new material layer 20 forms a cross-sectional layer of the component 12 and additional cross-sectional layers are deposited on top of a previous layer 22, 24 to form the three-dimensional component 12. The welding head 42 deposits the new material layer 20 on top of the second material layer 22. As the component 12 is constructed, new material layers 20 are deposited on the previously deposited material 22, 24.

As shown in FIG. 1, for example, the uppermost layer is new material layer 20, the layer adjacent and below new material layer 20 is the second material layer 22, and layers below second material layer 22 are referred to here as previous material layers 24. The welding head 42 deposits and welds a bead of material 30 of the new material layer 20 on to the second material layer 22. The new material layer 20 is translated through the roller assembly 18 and compressed such that parasitic mass in the new material layer 20 is redirected into the central portion of the new material layer 20. In some embodiments, new material layer 20 is translated through the roller assembly 18 after reaching a low enough temperature to be below the recrystallization temperature. In one embodiment using Inconel 625, the new material layer 20 passes through roller assembly 18 when the temperature of new material layer 20 is preferably below 1100° C. and more preferably below 870° C. The compression of the new material layer 20 refines the grain structure of the material, increases strength of the material, and improves the surface finish of component 12.

In the illustration of FIG. 1, the second material layer 22 and the previous material layers 24 have already undergone cold working by the roller assembly 18 at the time they were deposited as the new material layer. Immediately after deposition at the welding head 42 and before cold working by the roller assembly 18, the new material layer 20 is wider and contains additional parasitic mass compared to the second and previous material layers 22, 24 that were cold worked by the roller assembly 18 after deposition. In the illustrative example in FIG. 1, the bead of the new material layer 20 has a narrow neck where the new material layer 20 is fused to the second material layer 22. The new material layer 20 includes an inner side 26 and an outer side 28 that form approximately convex surfaces and balloon out such that the thickness of the new material layer 20 immediately after deposition by the welding head 42 is wider than the wall thickness of the second and previous material layers 22, 24.

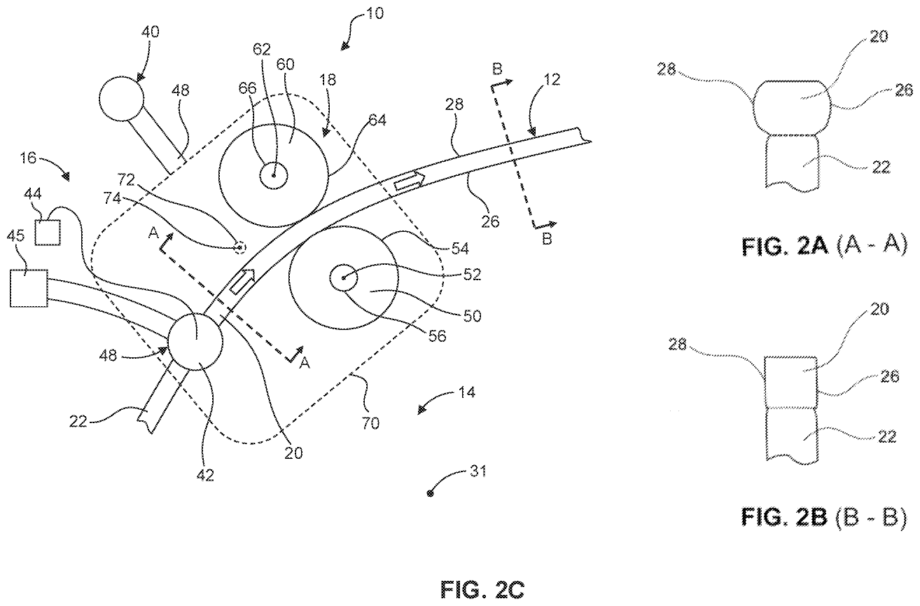

The platform 14 provides a surface that supports the component 12 during deposition and construction of component 12 as shown in FIGS. 1 and 2. In some embodiments, a sacrificial layer may be located between the platform 14 and component 12. In the illustrative embodiment in FIG. 2C, the platform 14 includes a pivot axis 31 and the platform 14 is configured to rotate around the pivot axis 31 to facilitate manufacture of components 12 with circular cross-sections, oval cross-sections, or other closed cross-sectional shapes. The platform 14 rotates in a circumferential direction and moves the component 12 under the welding head 42 and through the roller assembly 18. The welding robot 16 and roller assembly 18 are radially spaced apart from the pivot axis 31 depending on a desired diameter or dimension of the component 12.

In some embodiments, the platform 14 can be rotated at different speeds that may correlate to a deposition rate at the welding head 42. In some embodiments, the platform may be stationary, and the welding robot 16 and roller assembly 18 are translated relative to the platform 14 to generate the desired geometry of component 12. In some embodiments, the platform 14 translates in a linear direction to generate linear shapes of component 12, such as a straight wall. In some embodiments, the platform 14 can have multiple degrees of freedom and the welding robot 16 and the roller assembly 18 can also move relative to platform 14 to generate any shape of component 12 desired.

The welding robot 16 includes an articulating welding arm 40, a welding head 42, a wire spool 44, a power supply 45, and a sensor 46 as shown, for example, in FIG. 2C. Articulating welding arm 40 of the welding robot 16 allows for WAAM to be conducted throughout 3-D space, within the range of articulating welding arm 40 and welding head 42. Articulating welding arm 40 is secured to a surface, such as a floor or a working table. Articulating welding arm 40 also has a welding end 48, where welding head 42 is attached. Wire spool 44, power supply 45, and sensor 46 are coupled to welding head 42 and optionally coupled to the articulating welding arm 40. For example, the power supply 45 can provide power to manipulate articulating welding arm 40 along a tool path for a desired geometry of component 12. In another example, wire spool 44 can dispense metal wire through articulating welding arm 40. In another example, sensor 46 can be coupled to articulating welding arm 40 to evaluate the position of the welding head 42 with relation to the component 12.

Welding head 42 is coupled to the welding end 48 of articulating welding arm 40 and is configured to deposit new material layer 20 on to component 12 as shown, for example, in FIGS. 1 and 2C. Movement of welding head 42 can be controlled by movement of articulating welding arm 40. Welding head 42 has at least one output port used to provide metal wire stored on wire spool 44. The metal wire can be any metal or metal alloy, such as aluminum, an aluminum alloy, Niobium C-103, iron, or nickel alloys such as steel 308, Inconel 625, or Inconel 718. The rate at which the metal wire is fed from welding head 42 from wire spool 44 can be varied based on the component 12 being manufactured. At least one output port of welding head 42 can also be used to apply heat energy to a metal wire through an electric arc. The heat energy can be supplied by power supply 45. Sensor 46 can be one or more cameras, or other type of sensor to measure characteristics like deformation, vibration, and strain at the welding head 42. Deformation information of the new material layer 20 can be used to adjust platform 14, the welding robot 16, and/or the roller assembly 18.

Roller assembly 18 is configured to cold work new material layer 20 by compressing the thickness of new material layer 20 in the radial direction as shown, for example, in FIGS. 1-3. It will be appreciated that in some embodiments, roller assembly 18 exerts equal forces on both sides 26, 28 of new material layer 20 to achieve plastic deformation of new material layer 20. Equal forces may achieve a worked material layer having consistent material properties across the thickness of the material layer. The force applied by the roller assembly 18 will increase as new material layer 20 is compressed and strengthened during the working process. In some embodiments, roller assembly 18 may exert different forces on either side 26, 28 of new material layer 20 depending on the desired physical property of components 12. Roller assembly 18 is located adjacent to platform 14.

FIG. 2C is a diagrammatic top view of a system for cold working an additively manufactured component showing a welding head adjacent to a roller assembly, according to some embodiments of the present disclosure. In the illustrative embodiment shown in FIG. 2C, roller assembly 18 is coupled with the welding robot 16 at welding end 48 of articulating welding arm 40. The roller assembly 18 is spaced apart from the welding head 42 so that the welding head 42 deposits new material layer 20 before new material layer 20 is cold worked by roller assembly 18.

Illustrative cross sections of the component 12 are depicted in FIGS. 2A and 2B. FIG. 2A shows the cross section of component 12 at the axis depicted by the dashed line A-A. It depicts an exaggerated profile of the new material layer 20 after deposition on top of second material layer 22. Similarly, FIG. 2B shows the cross section of component 12 at the axis depicted by the dashed line B-B. It depicts an exaggerated profile of the new material layer 20 after passing through roller assembly 18. FIGS. 2A and 2B depict a single new material layer 20 and a second material layer 22. It will be appreciated that embodiments of the present invention may involve cold working of a single layer of new material, two layers of new material, or more layers of new material.

Roller assembly 18 includes first roller 50, second roller 60, and housing 70 as shown, for example, in FIGS. 1-3. First roller 50 and second roller 60 are located on opposite sides of component 12 and configured to cold work new material layer 20 of component 12. First and second rollers 50, 60 are rotatably coupled to housing 70. In the illustrative embodiment in FIG. 2C, housing 70 is coupled at the welding end 48 of articulating welding arm 40 and spaced apart from welding head 42. In some embodiments, welding head 42 may be directly coupled to housing 70 and circumferentially spaced apart from first and second rollers 50, 60. In the illustrative embodiment in FIG. 2C, housing 70 includes pivot 72 with pivot axis 74. It may be advantageous for housing 70 to rotate around pivot axis 74 to align first roller 50 and second roller 60 circumferentially relative to new material layer 20 of component 12. Any circumferential misalignment of first and second rollers 50, 60 may impart unwanted bending loads into component 12 during the cold working process.

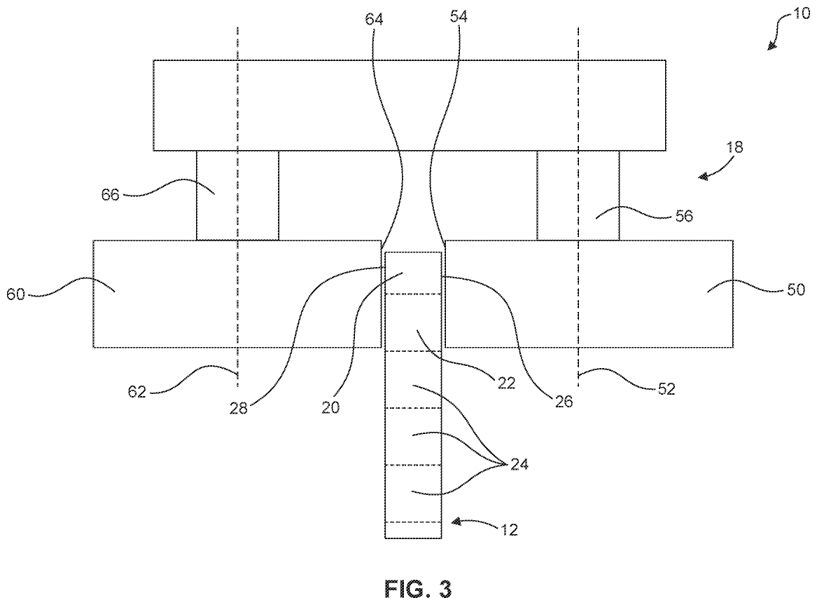

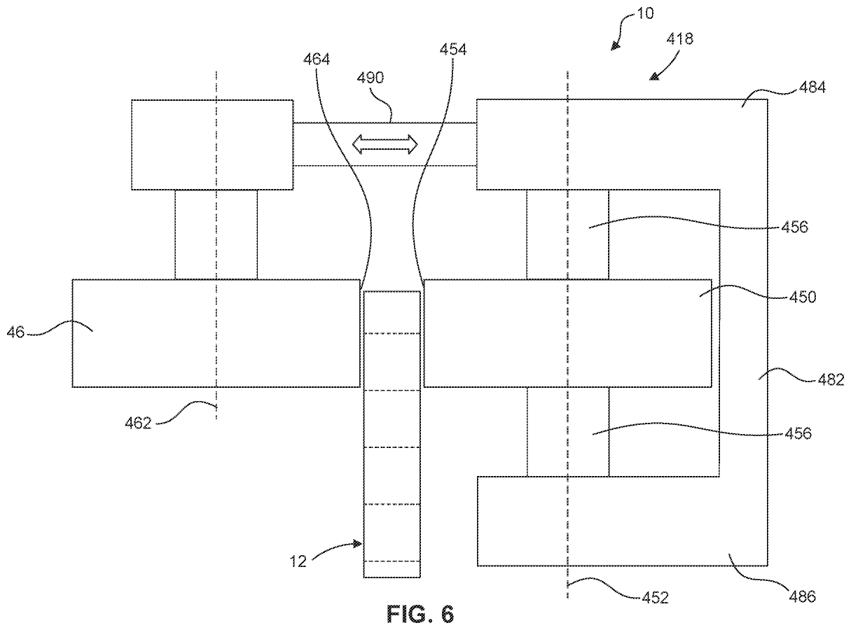

First roller 50 has cylindrical shape and rotates around first axis 52 as shown, for example, FIGS. 1-3. First roller 50 includes first rolling surface 54 that engages the inner side 26 of new material layer 20. First rolling surface 54 extends circumferentially around first roller 50 forming the perimeter surface of first roller 50. In some embodiments, first rolling surface 54 can be flat as illustratively shown in FIGS. 1 and 3, or can have convex or concave shape. First roller 50 is supported by first support axle 56 that rotates around first axis 52 and is rotatably coupled to housing 70 so that first roller 50 is freely rotatable relative to housing 70. In the illustrative embodiment in FIG. 3, first support axle 56 supports first roller 50 from an upper portion. In some embodiments, shown for example in FIG. 6 and described below, first support axle 56 may be rotatably coupled to housing 70 at upper and lower portions to provide additional stiffness with regard to bending moments or similar acting on first roller 50.

Second roller 60 has cylindrical shape and rotates around second axis 62 as shown, for example, FIGS. 1-3. Second roller 60 includes second rolling surface 64 that engages the outer side 28 of new material layer 20. Second rolling surface 64 extends circumferentially around second roller 60 forming the perimeter surface of second roller 60. In some embodiments, second rolling surface 64 can be flat as illustratively shown in FIGS. 1 and 3, or can have convex or concave shape. Second roller 60 is supported by second support axle 66 that rotates around second axis 62 and is rotatably coupled to housing 70 so that second roller 60 is freely rotatable relative to housing 70. In the illustrative embodiment in FIG. 3, second support axle 66 supports second roller 60 from an upper portion. In some embodiments, shown for example in FIG. 6 and described below, second support axle 66 may be rotatably coupled to housing 70 at upper and lower portions to provide additional stiffness with regard to bending moments or similar acting on second roller 60. In the illustrative embodiment in FIG. 3, first axis 52 and second axis 62 may be approximately parallel.

In the illustrative embodiment in FIGS. 1 and 3, first and second rolling surface 54, 64 extend along the entire axial height of first and second rollers 50, 60 respectively and are axially aligned. In some embodiments, first and second rolling surface 54, 64 may have axial heights greater than the axial height of new material layer 20. In some embodiments, first and second rolling surface 54, 64 can have axial heights 1.5 times greater than new material layer 20 such that first and second rolling surface 54, 64 engage inner and outer sides 26, 28 of new material layer 20 respectively and further extend partially adjacent to second material layer 22. In some embodiments, first and second rolling surface 54, 64 can have axial heights at least 2 times greater than new material layer 20 such that first and second rolling surface 54, 64 engage inner and outer sides 26, 28 of new material layer 20 respectively and further extend partially adjacent to second material layer 22. In some embodiments, first and second rolling surface 54, 64 can have axial heights such that first and second rolling surfaces 54, 64 engage inner and outer sides 26, 28 respectively of new material layer 20, extend adjacent to second material layer 22 and is adjacent to a portion of previous material layer 24.

In some embodiments, roller assembly 18 may further include a cooling device coupled with roller assembly 18 to provide a cooling fluid to first and second rollers 60 to control the temperature of the cold working process. In some embodiments, first and second rollers 50, 60 can be manufactured using a deposition printing process such that cooling fluid passages are formed inside the first and second rollers 50, 60 and the cooling device is coupled with the embedded cooling fluid passages. In some embodiments, the support axles 56, 66 can include cooling channels to control the temperature of the cold working process. In some embodiments, the cooling device may include jets that direct cooling fluid in proximity to the engagement of the first and second rollers 50, 60 with new material layer 20. In some embodiments, the roller assembly 18 can include a heating element to heat the rolling surfaces 54, 64 and control the temperature of the cold working process.

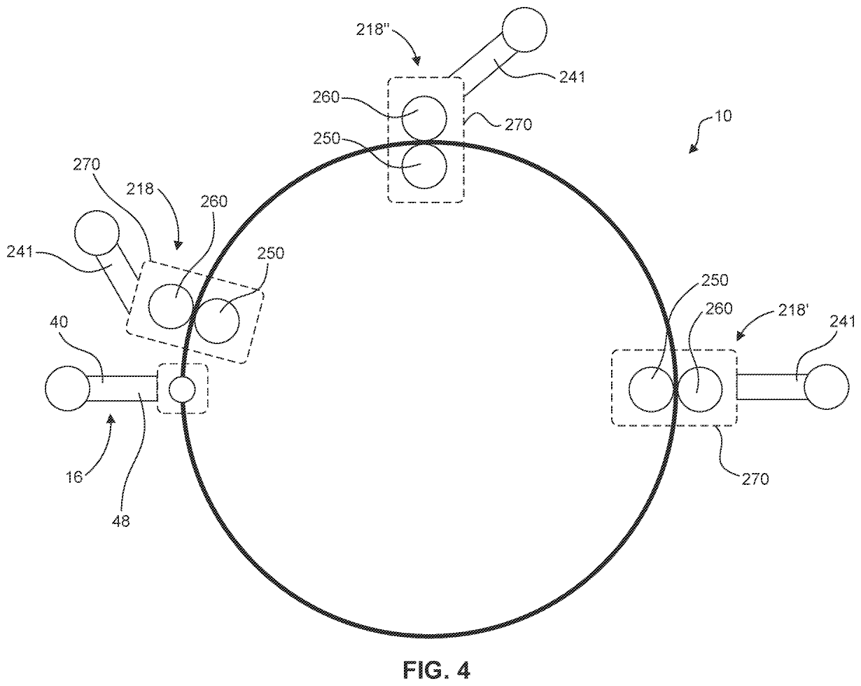

Another embodiment of a roller assembly 218 in accordance with the present disclosure is shown in FIG. 4 with three different possible locations for roller assemblies 218, 218′, 218″. The roller assembly 218 is substantially similar to the roller assembly 18 shown in FIGS. 1-3 and described herein. Accordingly, similar reference numbers in the 200 series indicate features that are common between the roller assembly 218 and the roller assembly 18. The description of the roller assembly 18 is incorporated by reference to apply to the roller assembly 218, except in instances when it conflicts with the specific description and the drawings of the roller assembly 218.

Roller assembly 218 includes first roller 250, second roller 260, housing 270, and articulating roller arm 241 as shown, for example, in FIG. 4. First roller 250 and second roller 260 are located on opposite sides of component 12 and configured to cold work new material layer 20 of component 12. First and second rollers 250, 260 are rotatably coupled to housing 270. Housing 270 is coupled to articulating roller arm 241 such that articulating roller arm 241 can translate housing 270 relative to platform 14 and component 12. In some embodiments, articulating roller arm 241 can include a power source and motors to manipulate first and second roller 218 and housing 270 along a tool path that corresponds to the tool path of the welding head 42 of welding robot 16.

Articulating roller arm 241 is secured to a surface, such as a floor or a working table. Articulating roller arm 241 is positioned adjacent to platform 14 and spaced apart and decoupled from articulating welding arm 40 such that movements in either the articulating welding arm 40 or the articulating roller arm 241 are isolated from one another and the components attached thereto. For example, small movements imparted on articulating roller arm 241 by first and second rollers 250, 260 do not impart a corresponding movement into articulating welding arm 40 and welding head 42. Small movements of the articulating roller arm 241 may be caused, for example, by interactions between the first and second rollers 250, 260 and the new material layer 20 due to non-uniform depositions of material. As such, the isolation of articulating welding arm 40 and articulating roller arm 241 may remove any positive feedback loop between the welding robot 16 and the roller assembly 218.

Roller assembly 218 may be positioned in a plurality of circumferential locations around platform 14 relative to welding head 42. In one embodiment of the present invention, roller assembly 218 might be positioned so that it is disposed to act on the new material layer 20 immediately after deposition. In another embodiment of the present invention, roller assembly might be positioned so that it is disposed to act on the previous material layer 22 immediately before depositing the new material layer 20. In yet another embodiment, roller assembly 218 may advantageously disposed at different locations relative to welding head 42 based on the desired temperature at roller assembly 218. It should be appreciated that the roller assembly 218 may be positioned using a variety of techniques and in a variety of locations according to embodiments of the present invention. For example, the roller assembly 218 can be coupled directly to component 12 according to one embodiment of the present invention. In alternative embodiments, the roller assembly 218 is held in such a way that it is secured to a member spaced from system 10. Such an arrangement might have the roller assembly 214 descending from a ceiling above system 10, either directly or located on a movable catenary arrangement or crane. In an alternate embodiment, roller assembly 218 is attached to a movable or robotic arm originating distal to system 10, such as on a factory floor, ceiling, or other area. In yet another alternate embodiment, roller assembly 218 is attached to a static beam originating distal to system 10.

The illustrative embodiment in FIG. 4 shows roller assembly 218 in a plurality of possible positions. For example, in a first position, roller assembly 218 can be positioned in close proximity to welding robot 16 such that new material layer 20 has a temperature is at or below the recrystallization temperature. In the first position, new material layer 20 may be above ambient temperature as it is worked by roller assembly 218 and the roller assembly may take advantage of the material being more malleable or softer in a heated state. This may have the advantage of the roller assembly 18 applying a lower compressive force on new material layer 20. In another example, roller assembly 218′ may be positioned in a second position, such that roller assembly 218′ is positioned on an opposite side of component 12 and/or platform 14. In the second position, the temperature of new material layer 20 will be cooler than in the first position, such that the cold working process may give advantages such as refining the grain structure and improving strength of the material. In another example, roller assembly 218″ may be positioned in a third position mid-way between the first position and second position such that the temperature of the new material layer 20 is less than the temperature of the new material layer 20 in the first position and greater than the temperature of the new material layer 20 in the second position. As such, the roller assembly 218, 218′, 218″ may be positioned in circumferential positions around component 12 that may vary the temperature at which new material layer 20 is cold worked by roller assembly 218.

It will be understood from the present disclosure that the temperature of the new material layer 20 when it is worked by the roller assembly may be a function of one or more of the relative distance between the relative distance between the welding head 42 and the roller assembly 218, the translating speed of the component between the welding head 42 and the roller assembly 218, and the relative cooling rate of the new material layer 20. It will be well understood from the present disclosure that working the new material layer 20 at a range of different temperatures may yield a variety of different material properties and it is contemplated that in some embodiments of the present invention that the temperature at which the new material layer 20 is worked by roller assembly 218 will affect the material performance of component 12. Further, working the new material layer 20 at a range of different temperatures may vary the compressive of force applied by roller assembly 18 to plastically deform new material layer 20.

In some embodiments, system 10 may include a single roller assembly 218 positioned in any of the plurality of positions described above. In some embodiments, system 10 may include at least two roller assemblies 218 circumferentially spaced apart from one another and in any of the plurality of positioned described above. This may be referred to as a compound rolling assembly. In this embodiment, the new material layer 20 may have increasing compressive force applied by each of the roller assemblies 218 as the component 12 translates and/or rotates around the platform 14. For example, a first roller assembly 218 in the first position may cold work new material layer 20 to a first thickness or first compressive force, and a second roller assembly 218′ may cold work new material layer 20 to a second thickness smaller than the first thickness or a second compressive force larger than the first compressive force.

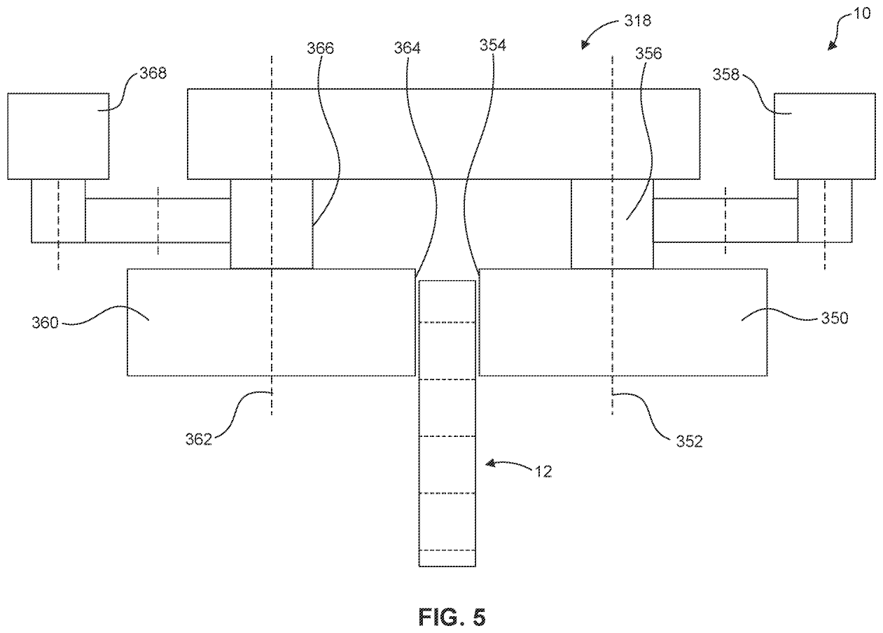

Another embodiment of a roller assembly 318 in accordance with the present disclosure is shown in FIG. 5. The roller assembly 318 is substantially similar to the roller assembly 18 shown in FIGS. 1-3 and described herein. Accordingly, similar reference numbers in the 300 series indicate features that are common between the roller assembly 318 and the roller assembly 18. The description of the roller assembly 18 is incorporated by reference to apply to the roller assembly 318, except in instances when it conflicts with the specific description and the drawings of the roller assembly 318.

Roller assembly 318 includes first roller 350, first roller motor 358, second roller 360, and second roller motor 368 as shown, for example, in FIG. 5. First roller 350 and second roller 360 are located on opposite sides of component 12 and driven by first roller motor 358 and second roller motor 368 respectively. In some embodiments described above, first and second rollers 50, 60 may not be driven so rotation of the rollers may be caused by friction between the new material layer 20 and first and second roller surfaces 54, 64 of first and second roller 50, 60. Friction between the new material layer 20 and first and second rolling surfaces 354, 364 of first and second roller 350, 360 may be reduced by providing rotational drive to the first and second rollers 350, 360. Reduced friction at the cold working interface may reduce temperature and/or improve material capabilities of the component 12.

First roller 350 includes first rolling surface 354 and is rotatably coupled with first support axle 356 to be driven around first axis 352 as shown, for example in FIG. 5. First support axle 356 may include a geared surface that engages with a drive gear coupled to first roller motor 358 to provide rotational drive between the first roller 350 and the first roller motor 358. Second roller 360 includes second rolling surface 364 and is rotatably coupled with second support axle 366 to be driven around second axis 362 as shown, for example in FIG. 5. Second support axle 366 may include a geared surface that engages with a drive gear coupled to second roller motor 368 to provide rotational drive between the second roller 360 and the second roller motor 368. First and second roller motors 358, 368 may be configured to drive first and second rollers 350, 360 in a direction that corresponds to the direction of travel of new material layer 20 of component 12. As such first roller 350 and second roller 360 are rotated in opposite directions.

In the illustrative embodiment in FIG. 5, an idler gear connects first support axle 356 and first roller motor 358, and second support axle 366 and second roller motor 368 to provide rotational drive therebetween. In some embodiments, first support axle 356 and second support axle 366 may be powered by a common drive shaft powered by a single motor. For example, the common drive shaft may be a worm gear that engages geared teeth in each of the first and second support axles 356, 366. In some embodiments, first and second support axles 356, 366 may be included in a gear assembly with a plurality of gears to drive first and second rollers as a predetermined rotational speed. In some embodiments, first roller motor 358 and second roller motor 368 may be configured to rotate first roller 350 and second roller 360 at different rotational speeds to accommodate for a radius of component 12. In another embodiment, a roller assembly has two rollers positioned on outer side 28 and a single roller positioned on inner side 26 of component 12.

Another embodiment of a roller assembly 418 in accordance with the present disclosure is shown in FIG. 6. The roller assembly 418 is substantially similar to the roller assembly 18 shown in FIGS. 1-3 and described herein. Accordingly, similar reference numbers in the 400 series indicate features that are common between the roller assembly 418 and the roller assembly 18. The description of the roller assembly 18 is incorporated by reference to apply to the roller assembly 418, except in instances when it conflicts with the specific description and the drawings of the roller assembly 418.

Roller assembly 418 includes first roller 450, second roller 460, fixed support wall 482, and articulation device 490 coupled between first and second rollers 450, 460 as shown, for example, in FIG. 6. Articulation device 490 is configured to adjust a distance between first and second rollers 450, 460, and/or control a compressive force applied by first and second rollers 450, 460 on to new material layer 20. By controlling a distance or force between the first and second rollers 450, 460, the component 12 may be optimized for surface finish, component inspection, and/or material properties. In some embodiments, articulation device 490 may vary the distance and/or force applied between the first and second rollers for different circumferential portions of the component 12 to vary component or material property of the component 12 in the respective circumferential portions.

In the illustrative embodiment, first roller 450 is coupled to fixed support wall 482 such that articulation device 490 translates second roller 460 relative to first roller 450. Second roller 460 and second moveable axis 462 may be translated in the radial direction toward or away from first roller 450 and first axis 452 to adjust the distance between first and second roller surfaces 454, 464 and/or control the compressive force applied therebetween. Alternatively, second roller 460 may be coupled to a fixed wall, and articulation device 490 translates first roller 450 relative to second roller 460. In some embodiments, articulation device 490 may be a hydraulic piston, a worm gear, or other actuator to control the distance or force between the first and second rollers 450, 460. In some embodiments, articulation device 490 may include two or more devices working in parallel between first and second rollers to avoid imparting a moment on articulation device 490.

In the illustrative embodiment in FIG. 6, roller assembly 418 further includes upper arm 484 and lower arm 486 that support first support axle 456. First support axle 456 is rotatably coupled at an upper portion to upper arm 484 and at a lower portion to lower arm 486. Upper arm 484 and lower arm 486 are coupled together via fixed support wall 482 to provide additional stiffness to roller assembly 418 and resist bending moments applied to first roller 450. Increased stiffness of the roller assembly may increase accuracy of the cold working process. The upper and lower arm 484, 486 configuration may be applied to any of the embodiments disclosed above to increase stiffness of the roller assemblies. The upper and lower arm 484, 486 configuration may be connected by a fixed wall, such as fixed support wall 482, or a free wall that has additional degrees of freedom in any of the axial, tangential, and circumferential directions.

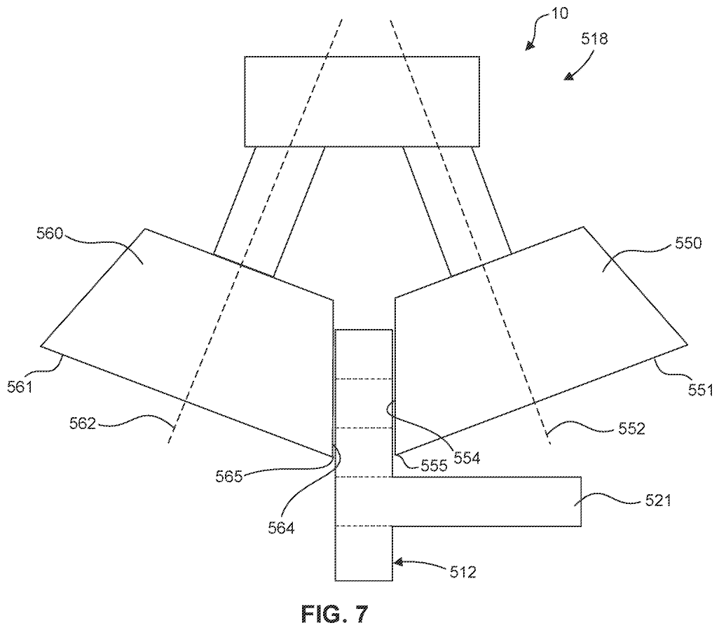

Another embodiment of a roller assembly 518 in accordance with the present disclosure is shown in FIG. 7. The roller assembly 518 is substantially similar to the roller assembly 18 shown in FIGS. 1-3 and described herein. Accordingly, similar reference numbers in the 500 series indicate features that are common between the roller assembly 518 and the roller assembly 18. The description of the roller assembly 18 is incorporated by reference to apply to the roller assembly 518, except in instances when it conflicts with the specific description and the drawings of the roller assembly 518.

Roller assembly 518 includes first conical roller 550 and second conical roller 560 as shown, for example, in FIG. 7. First conical roller 550 may rotate around first axis 552 and second conical roller 560 may rotate around second axis 562. First axis 552 and second axis 562 are non-parallel, and orientated such that first rolling surface 554 of first conical roller 550 and second rolling surface 564 of second conical roller 560 are parallel and/or tangential to the worked surface of component 512. The angle of first and second rolling surfaces 554, 564 relative the first and second axes 552, 562 allow bottom surfaces 551, 561 of the first and second conical rollers 550, 560 to be axially spaced apart from a lower working portion 555, 565 of the first and second rolling surfaces 554, 564. For example, where component 512 includes a tangentially extending feature such as flange 521, roller assembly 518 may cold work axial layers of material in close proximity of flange 521 without contacting flange 521.

In some embodiments, the angles of first and second axes 552, 562 may be adjusted independently to accommodate a radius of component 512 in the axial direction, such as, for example, a dome shape positioned at the top of a cylinder. The angles of first and second axes 552, 562 may also be adjusted to reduce slip between the new material layer and one or both of first rolling surface 554 of first conical roller 550 and second rolling surface 564 of second conical roller 560. It will also be appreciated that some embodiments of the present invention may adjust the angles of roller axes of cylindrical rollers (e.g. roller assemblies 18, 218, 318, 418). In such an embodiment, the angles or roller axes may either be adjusted together or independently.

It is to be appreciated that the Detailed Description section, and not any other section, is intended to be used to interpret the claims. Other sections can set forth one or more but not all aspects as contemplated by the inventors, and thus, are not intended to limit this disclosure or the appended claims in any way.

While this disclosure describes example embodiments for example fields and applications, it should be understood that the disclosure is not limited thereto. Other embodiments and modifications thereto are possible, and are within the scope and spirit of this disclosure. For example, and without limiting the generality of this paragraph, embodiments are not limited to the hardware and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “an embodiment,” “some embodiments,” “an example,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art to incorporate such feature, structure, or characteristic into other embodiment whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described embodiments, which are merely examples, but should be defined only in accordance with the following claims and their equivalents.

What is claimed is:

1. A system for working an additively manufactured component, the system comprising:
a platform configured to support a three-dimensional object;
a deposition robot configured to deposit successive material layers that, after deposition, form the three-dimensional object, the deposition robot comprising:
an articulating robotic arm having a deposition end;
a deposition head, coupled to the deposition end of the arm, and configured to deposit a new material layer of the successive material layers; and
a roller assembly disposed around the new material layer and configured to compress a lateral thickness of the new material layer after the new material layer has been deposited by the deposition robot.

2. The system of claim 1, wherein the roller assembly is coupled to the articulating robotic arm and spaced apart from the deposition head.

3. The system of claim 1, wherein the roller assembly is coupled to a second articulating robotic arm independent of the articulating robotic arm of the deposition robot.

4. The system of claim 1, wherein the platform rotates around an axis and the three-dimensional object has a continuous perimeter.

5. The system of claim 4, wherein the roller assembly is circumferentially spaced apart from the deposition robot around the axis.

6. The system of claim 1, wherein the roller assembly includes a first roller that rotates around a first roller axis and a second roller that rotates around a second roller axis, the first and second rollers are axially aligned with the new material layer.

7. The system of claim 6, wherein the first and second rollers include a rolling surface, each rolling surface extending axially and configured to engage the new material layer and a second material layer.

8. The system of claim 7, wherein the rolling surface is convex.

9. The system of claim 7, wherein the roller assembly is rotatable around a pivot axis such that the first and second rollers are spaced apart from each other tangential to the new material layer.

10. The system of claim 7, wherein the first and second rollers are coupled to a motor and configured to rotate to reduce friction between the first and second rollers and the new material layer.

11. The system of claim 7, wherein the roller assembly further comprises an articulation device to control at least one of a compressive force acting on the new material layer by the first and second rollers and a distance between the first and second rollers.

12. The system of claim 7, wherein the first and second rollers have a conical cross-section and wherein the first and second axes are non-parallel.

13. The system of claim 7, wherein the first roller is supported by a first support arm and the second roller is supported by a second support arm.

14. The system of claim 7, wherein the roller assembly further includes cooling passages configured to supply a cooling medium to the new material layer.

15. The system of claim 1, wherein the platform extends linearly and the three-dimensional object is a wall.

16. A system for cold working an additively manufactured component, the system comprising:
a platform configured to support a three-dimensional object;
a deposition robot configured to deposit a new successive material layers that, after deposition, form the three-dimensional object, the deposition robot comprising:
an articulating robotic arm having a deposition end;
a deposition head, coupled to the deposition end of the articulating robotic arm, configured to deposition a new material later of the successive material layers; and
a power supply coupled to the deposition robot; and
a roller assembly disposed around the new material layer and configured to compress a lateral thickness of the new material layer after the new material layer has been deposited by the deposition robot.

17. The system of claim 16, wherein the roller assembly is coupled to the articulating robotic arm and spaced apart from the deposition head.

18. The system of claim 16, wherein the roller assembly is coupled to a second articulating robotic arm independent of the articulating robotic arm of the deposition robot.

19. The system of claim 16, wherein the platform rotates around a pivot axis and the three-dimensional object has a continuous perimeter.

20. A deposition robot configured to deposit successive material layers that, after deposition, form the three-dimensional object, the deposition robot comprising:
an articulating robotic arm having a deposition end;
a deposition head, coupled to the deposition end of the arm, configured to deposit a new material layer of the successive material layers; and
a roller assembly coupled to the articulating robotic arm and spaced apart from the deposition head, wherein the roller assembly is disposed around the new material layer and configured to compress a lateral thickness of the new material layer after the new material layer has been deposited by the deposition robot.
